(19) United States
(12) Patent Application Publication
(10) Pub. No.: US 2017/0241476 A1
(43) Pub. Date: Aug. 24, 2017

(54) BEARING HAVING AN OUTER RING AND ROLLING ELEMENT PILOTED CAGE

(71) Applicant: Schaeffler Technologies AG & Co. KG, Herzogenaurach (DE)

(72) Inventor: William Moratz, Gardiner, NY (US)

(21) Appl. No.: 15/051,128

(22) Filed: Feb. 23, 2016

(51) Int. Cl. F16C 33/38; F16C 19/16

(52) U.S. Cl. CPC F16C 33/3806; F16C 19/163; F16C 2322/39

(57) ABSTRACT

A bearing including an axis of rotation, an inner ring, an outer ring arranged radially outward of the inner ring, the outer ring including a radially inner circumferential surface including: a race surface, a first outer ring portion arranged closer, in a first radial direction, to the axis of rotation than the race surface, and a second outer ring portion arranged closer, in the first radial direction, to the axis of rotation than the race surface and the first outer ring portion. The bearing further includes a cage radially arranged between the inner and outer rings.

### TECHNICAL FIELD

The present disclosure relates broadly to high speed bearings, and, more particularly, to spindle bearings in production machinery.

### BACKGROUND

Ball guided cages are preferred in order to provide a bearing that is quiet. Typically, high speed bearings have an outer ring piloted cage. For example, FIG. 3 illustrates prior art bearing 80 having outer ring piloted asymmetrical cage 81 arranged between inner ring 82 and outer ring 84. Outer ring 84 has a radially inner circumferential surface including portions 85 and 86. Portion 85 is arranged distance D1 from axis of rotation AR and portion 86 is arranged distance D2 from axis of rotation AR. Distance D1 is larger than distance D2. Asymmetrical cage 81 includes radially outer circumferential surface 88 which is arranged to be piloted by radially inner circumferential surface portion 85. Unfortunately, such outer ring piloted cages are unstable and noisy due to the high pitch diameter of the bearing and the high pitch line velocity of the cage. A piloting surface having a high diameter results in additional rubbing between the outer ring and the cage, which interferes with the ability of the cage to spin freely.

### SUMMARY

According to aspects illustrated herein, there is provided a bearing including an axis of rotation, an inner ring, an outer ring arranged radially outward of the inner ring, the outer ring including a radially inner circumferential surface including: a race surface, a first outer ring portion arranged closer, in a first radial direction, to the axis of rotation than the race surface, and a second outer ring portion arranged closer, in the first radial direction, to the axis of rotation than the race surface and the first outer ring portion. The bearing further includes a cage radially arranged between the inner and outer rings, the cage comprising a radially outer circumferential surface including: a first cage portion and a second cage portion axially aligned with the first cage portion so that a line, parallel to the axis of rotation, passes through the first and second cage portions and at least one rolling element positioned within the cage axially between the first and second cage portions.

According to aspects illustrated herein, there is provided a bearing including an axis of rotation, an inner ring, an outer ring arranged radially outward of the inner ring, the outer ring comprising: a radially inner circumferential surface, the radially inner circumferential surface having: a race surface, a first outer ring portion arranged closer, in a first radial direction, to the axis of rotation than the race surface, a space formed between the race surface and the first outer ring portion along the radially inner circumferential surface, a cage radially arranged between the inner and outer rings, and at least one rolling element positioned within the cage, wherein a circumferential line, about the axis of rotation, passes through the space without contacting the cage, the outer race, or the at least one rolling element.

According to aspects illustrated herein, there is provided a bearing including an axis of rotation, an inner ring, an outer ring arranged radially outward of the inner ring, the outer ring having a radially inner circumferential surface located a first distance, orthogonal to the axis of rotation, from the axis of rotation, a cage radially arranged between the inner and outer rings, the cage comprising a radially outer circumferential surface including: a first cage portion located a second distance, orthogonal to the axis of rotation, from the axis of rotation, the second distance being less than the first distance and a second cage portion located a third distance, orthogonal to the axis of rotation, from the axis of rotation, the third distance being equal to the second distance and less than the first distance, and at least one rolling element positioned within the cage.

According to aspects illustrated herein, there is provided a bearing including an axis of rotation, an inner ring, an outer ring arranged radially outward of the inner ring, a cage radially arranged between the inner and outer rings, the cage comprising a radially outer circumferential surface including: a first cage portion and a second cage portion axially aligned with the first portion so that a line, parallel to the axis of rotation, passes through the first and second cage portions, and at least one rolling element positioned within the cage axially between the first and second cage portions.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a schematic partial cross-sectional view of a bearing having an outer ring and rolling element piloted cage; and,

FIG. 3 is a schematic partial cross-sectional view of a prior art bearing.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. By “non-rotatably connected” components, we mean that the two components are connected so that whenever one of the components rotates the other component rotates and vice versa.

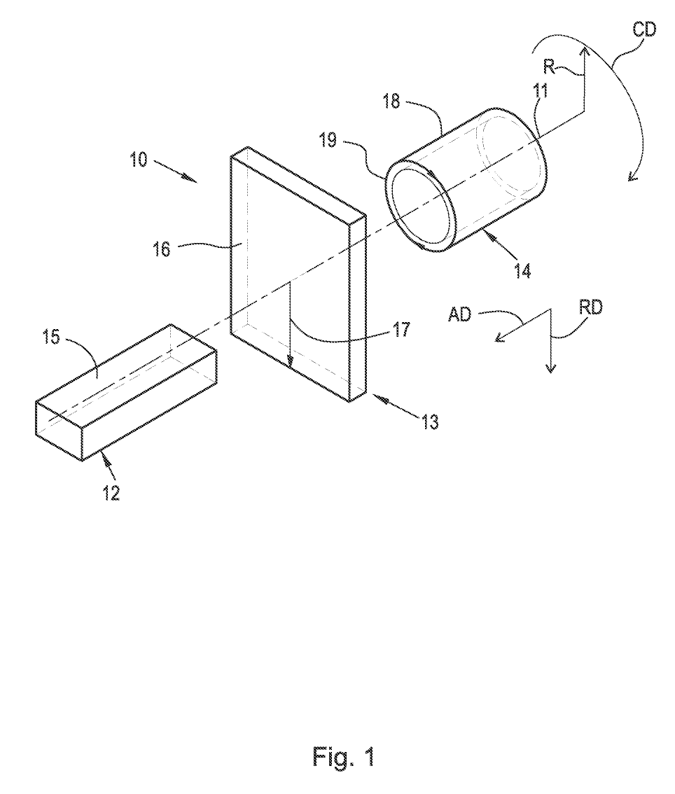

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane parallel to axis 11. Axis 11 is coplanar with planar surface 15; however it is not necessary for an axial surface to be coplanar with axis 11. A radial surface, such as surface 16 of object 13, is formed by a plane orthogonal to axis 11 and coplanar with a radius, for example, radius 17. Surface 18 of object 14 forms a circumferential, or cylindrical, surface. For example, circumference 19 forms a circle on surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively.

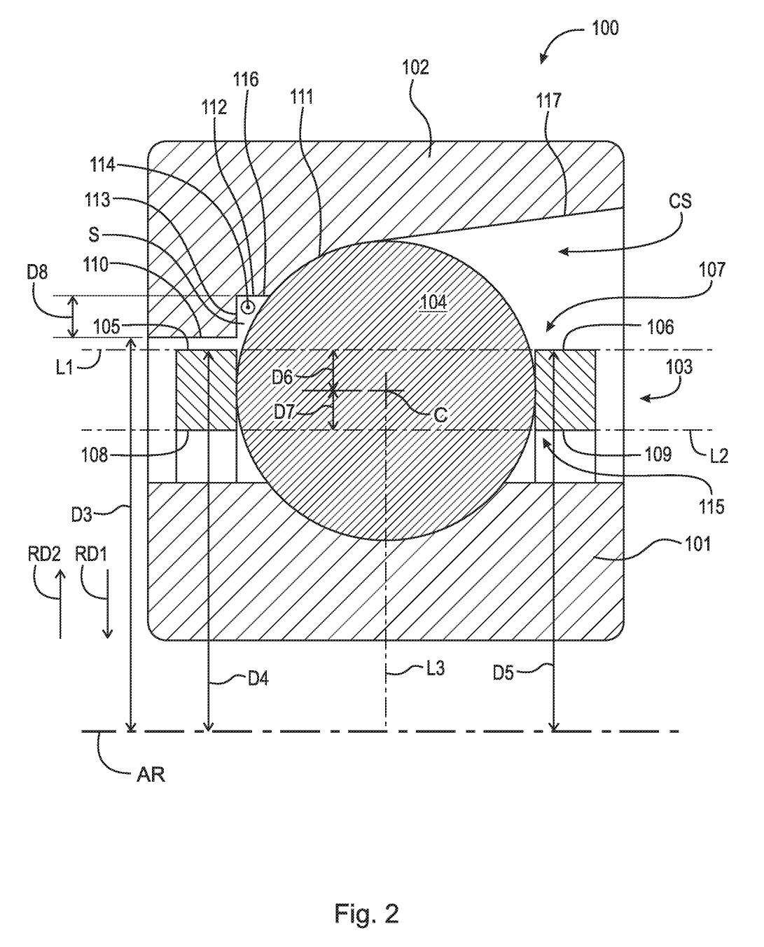

FIG. 2 is a schematic partial cross-sectional view of a bearing having an outer ring and rolling element piloted cage. Bearing 100 includes axis of rotation AR, inner ring 101, outer ring 102, cage 103 and at least one rolling element 104. Outer ring 102 is arranged radially outward of inner ring 101. Outer ring 102 includes radially inner circumferential surface CS which includes race surface 111, outer ring portion 112 arranged closer, in radial direction RD1, to axis of rotation AR than race surface 111, and outer ring portion 110 arranged closer, in radial direction RD1, to axis of rotation AR than race surface 111 and outer ring portion 112. Cage 103 is radially arranged between inner ring 101 and outer ring 102. Cage 103 includes radially outer circumferential surface 107 including cage portions 105 and 106. Cage portion 106 is axially aligned with cage portion 105 so that line L1, parallel to axis of rotation AR, passes through both cage portions 105 and 106. At least one rolling element 104 is positioned within cage 103 axially between cage portions 105 and 106. Hereinafter, a single element 104 is referenced. However, it should be understood that the discussion for the single element 104 is applicable to elements 104 in a plurality of elements 104.

No line, parallel to axis of rotation AR, passes through cage 103 and outer ring 102. Cage 103 is substantially symmetrical about center C of rolling element 104. In other words, cage 103 is substantially symmetrical about line L3 orthogonal to axis of rotation AR. Outer ring 102 includes radially inner circumferential surface CS located a distance D3 from axis of rotation AR. Cage portions 105 and 106 are located distances D4 and D5, respectively, from axis of rotation AR. Distance D3 is larger than both distances D4 and D5. Distance D4 is equal to distance D5.

Cage 103 contacts rolling element 104 and is piloted by outer ring portion 110 of radially inner circumferential surface CS.

Surface CS includes race surface 111, outer ring portion 112, and outer ring portion 110 arranged closer, in radial direction RD1, to axis of rotation AR, than race surface 111 and outer ring portion 112, and space S formed between race surface 111 and outer ring portion 110 along radially inner circumferential surface CS. Outer ring portion 110 is located distance D8 in radial direction RD1 from outer ring portion 112 toward axis of rotation AR to pilot cage 103. In an example embodiment, space S is formed between outer ring portions 110 and 112. Circumferential line 114, about axis of rotation AR, passes through space S without contacting cage 103, outer race 102, or rolling element 104. Rolling element 104 is in contact with race surface 111.

Space S is formed by radially extending portion 113 of radially inner circumferential surface CS, axially extending portion 114 of radially inner circumferential surface CS and rolling element 104. Radially extending portion 113 and axially extending portion 114 are free of contact with rolling element 104.

In an example embodiment, cage portion 106 is axially aligned with cage portion 105 so that line L1, parallel to axis of rotation AR, passes through both cage portions 105 and 106 and is co-linear with cage portions 105 and 106. In an example embodiment, cage 103 includes radially inner circumferential surface 115 including cage portions 108 and 109 axially aligned so that line L2, parallel to axis of rotation AR, passes through cage portions 108 and 109 and is co-linear with cage portions 108 and 109.

In an example embodiment, cage portions 105 and 106 are radially arranged distance D6 from center point C of rolling element 104 and cage portions 108 and 109 are radially arranged distance D7 from the center point C. In an example embodiment, distances D6 and D7 are equal.

In an example embodiment, rolling element 104 is centered axially and radially in cage 103.

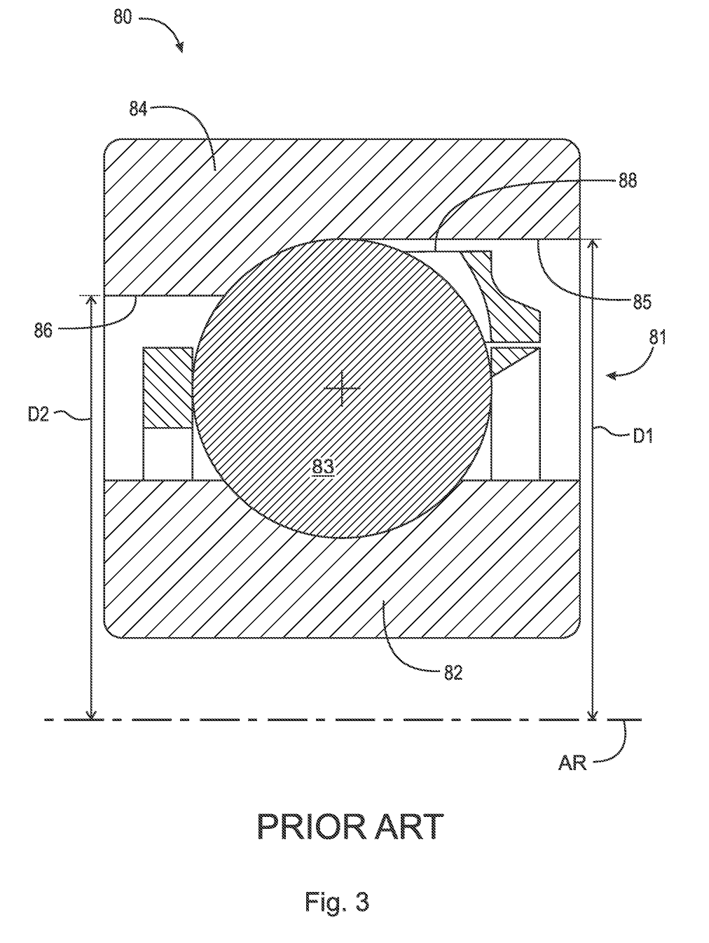

Advantageously, bearing 100 addresses the problem of cages noted above. Bearing 80 in FIG. 3 includes portion 86 which is spaced apart from cage 81. In contrast, bearing 100 includes outer ring portion 110 of surface CS which is spaced closer to radially outer circumferential surface 107 of cage 103. Outer ring portion 110 of outer ring 102 allows for a hybrid cage guidance between rolling element 104 and outer ring 102. Due to the reduction of distance D3 for outer ring portion 110 of surface CS, and the reduction in distances D4 and D5 for cage portions 105 and 106 of radially outer circumferential surface 107 of cage 103, the pitch diameter of bearing 100 is reduced and the pitch line velocity of cage 103 is reduced. The reduced pitch diameter of bearing 100 and the reduced pitch line velocity of cage 103 result in a more stable and quiet bearing. Cage 103 is preferably phenolic.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A bearing, comprising:
an axis of rotation;
an inner ring;
an outer ring arranged radially outward of the inner ring, the outer ring including a radially inner circumferential surface comprising:
a race surface;
a first outer ring portion arranged closer, in a first radial direction, to the axis of rotation than the race surface;
a second outer ring portion arranged closer, in the first radial direction, to the axis of rotation than the race surface and the first outer ring portion; and
a third outer ring portion, the third outer ring portion being linear and nonparallel to the axis of rotation;
a cage radially arranged between the inner and outer rings, the cage comprising a radially outer circumferential surface including:
a first cage portion; and,
a second cage portion radially aligned with the first cage portion so that a line, parallel to the axis of rotation, passes through the first and second cage portions; and,
at least one rolling element positioned within the cage axially between the first and second cage portions.

2. The bearing recited in claim 1, wherein no line, parallel to the axis of rotation, passes through the cage and the outer ring.

3. The bearing recited in claim 1, wherein the cage is symmetrical about a center of the at least one rolling element.

4. The bearing recited in claim 1, wherein:
the radially inner circumferential surface is located a first distance from the axis of rotation; and,
the first and second cage portions are located second and third distances, respectively, from the axis of rotation, wherein:
the first distance is larger than both the second and third distances.

5. The bearing recited in claim 1, wherein:
the cage contacts the at least one rolling element; and,
the cage is piloted by the radially inner circumferential surface of the outer ring.

6. A bearing, comprising:
an axis of rotation;
an inner ring;
an outer ring arranged radially outward of the inner ring, the outer ring comprising:
a radially inner circumferential surface, the radially inner circumferential surface having:
a race surface;
a first outer ring portion arranged closer, in a first radial direction, to the axis of rotation than the race surface;
a space formed between the race surface and the first outer ring portion along the radially inner circumferential surface; and
a second outer ring portion arranged farther, in a second radial direction, opposite the first radial direction, than the race surface, the second outer ring portion being linear and nonparallel to the axis of rotation;
a cage radially arranged between the inner and outer rings; and,
at least one rolling element positioned within the cage, wherein a circumferential line, about the axis of rotation, passes through the space without contacting the cage, the outer ring, or the at least one rolling element.

7. The bearing recited in claim 6, wherein no line parallel to the axis of rotation passes through the cage and the outer ring.

8. The bearing recited in claim 6, wherein the space is formed by:
a radially extending portion of the radially inner circumferential surface;
an axially extending portion of the radially inner circumferential surface; and,
the at least one rolling element.

9. The bearing recited in claim 8, wherein the radially extending portion and the axially extending portion are free of contact with the at least one rolling element.

10. The bearing recited in claim 6, wherein the at least one rolling element is in contact with the race surface.

11. The bearing recited in claim 6, wherein the cage is symmetrical about a line orthogonal to the axis of rotation.

12. The bearing recited in claim 6, wherein:
the cage includes first portion and a second portion of a radially outer circumferential surface;
the first portion and the second portion are located at a first distance and a second distance from the axis of rotation, respectively; and,
the radially inner circumferential surface is located a third distance from the axis of rotation, the third distance being larger than the first and second distances.

13. The bearing recited in claim 12, wherein the first and second cage portions are radially aligned so that a line, parallel to the axis of rotation, passes through the first and second cage portions and is co-linear with the first and second cage portions.

14. A bearing, comprising:
an axis of rotation;
an inner ring;
an outer ring arranged radially outward of the inner ring, the outer ring having a radially inner circumferential surface located a first distance, orthogonal to the axis of rotation, from the axis of rotation, the radially inner circumferential surface including an outer ring portion being linear and nonparallel to the axis of rotation;
a cage radially arranged between the inner and outer rings, the cage comprising a radially outer circumferential surface including:
a first cage portion located a second distance, orthogonal to the axis of rotation, from the axis of rotation, the second distance being less than the first distance; and,
a second cage portion located a third distance, orthogonal to the axis of rotation, from the axis of rotation, the third distance being equal to the second distance and less than the first distance; and,
at least one rolling element positioned within the cage.

15. The bearing recited in claim 14, wherein no line, parallel to the axis of rotation, passes through the cage and the outer ring.

16. The bearing recited in claim 14, wherein the at least one rolling element is centered axially and radially in the cage.

17. The bearing recited in claim 14, wherein:
the cage contacts the at least one rolling element; and,
the cage is piloted by the radially inner circumferential surface.

18. The bearing recited in claim 14, wherein the cage further includes a radially inner circumferential surface with third and fourth cage portions axially aligned so that a line, parallel to the axis of rotation, passes through the third and fourth cage portions and is co-linear with the third and fourth cage portions.

19. The bearing recited in claim 18, wherein:
the first and second cage portions are arranged a fourth distance from a centerline of the at least one rolling element; and,
the third and fourth cage portions are arranged radially a fifth distance, equal to the fourth distance, from the centerline.

20. The bearing recited in claim 14, wherein:
the cage contacts the at least one rolling element; and,
the cage is piloted by the radially inner circumferential surface of the outer ring.
